(19) United States
(12) Patent Application Publication
(10) Pub. No.: US 2004/0242176 A1
(43) Pub. Date: Dec. 2, 2004

(54) Device for down-transforming the frequency of signals

(76) Inventor: Johannes Sophia Vromans, Eindhoven (NL)

Correspondence Address: PHILIPS ELECTRONICS NORTH AMERICA CORPORATION, INTELLECTUAL PROPERTY & STANDARDS, 1109 MCKAY DRIVE, M/S-41SJ, SAN JOSE, CA, 95131, US

(21) Appl. No.: 10/481,985

(22) PCT Filed: Jun. 21, 2002
(86) PCT No.: PCT/IB02/02441

(30) Foreign Application Priority Data
Jun. 25, 2001 (EP) 01202435.2

(51) Int. Cl. H04B 1/18

(52) U.S. Cl. 455/173.1; 455/165.1

(57) ABSTRACT

Device for down-transforming the frequency of signals, for example radio and/or television signals.

The device comprises a transformer unit with quadrature channels for transforming the signals into quadrature signals of a lower frequency. The device further comprises a filter unit for suppressing mirror frequencies.

The filter unit comprises an amplitude and phase correction filter for correcting the quadrature signals and a correction control unit for controlling the filter.

The device further comprises a frequency generator which supplies reference signals having a frequency within the frequency band of the mirror signals to the input of the transformer unit.

The present invention relates to a device for down-transforming the frequency of signals, comprising a transformer unit with quadrature channels for transforming the signals into quadrature signals of a lower frequency, and a filter unit connected thereto for suppressing mirror frequencies occurring as a result of amplitude and phase errors in the quadrature signals, which filter unit comprises a controllable amplitude and phase correction filter for amplitude and phase correction of the quadrature signals, as well as a correction control unit which supplies the adjusting signals for the amplitude and phase correction filter in response to the output signals from said filter.

Such a device, which is known, can be used in radio FM receivers, television receivers and the like.

Since differences in amplification and phase shift, which differences will be referred to as amplitude and phase errors herein, invariably occur in the quadrature channels, so-termed mirror frequencies occur in the quadrature channels. This phenomenon has been known for a long time and many proposals for suppressing said mirror frequencies have been made and carried into practice. The information required for amplitude and phase correction of the quadrature signals such that mirror frequencies are suppressed can be derived from the quadrature signals themselves. It is known to do so by making use of, for example, an adjustable amplitude and phase correction filter for amplitude and phase correction of the quadrature signals and a correction control unit, which supplies the adjusting signals for the amplitude and phase correction filter in response to the output signals from said filter.

The differences in amplitude and phase between the quadrature signals are frequency-dependent, however, so that generally the corrections for one frequency need not be the same as the corrections for another frequency. An amplitude and phase correction for one particular frequency will not be sufficient at all times, therefore. In order to make it possible to effect corrections for several frequencies, the correction control unit needs to be able to derive the required information from the input signal. The fact is that the input signals do not exhibit a uniform spectral distribution at all times; in the case of TV signals, for example, the spectrum round the picture carrier frequency is dominant, as a result of which an optimum mirror frequency suppression can only be obtained for this particular frequency, whilst the quadrature channels may exhibit a much greater “mismatch” for other frequencies. Furthermore, it is desirable in some cases to be able to determine for which frequencies the correction of the quadrature signals relative to each other must take place; it may suffice to effect a correction only for that frequency or those frequencies at which the greatest error occurs. Furthermore, it must be possible to determine and correct the quadratic error across various frequencies.

Other methods of suppressing mirror frequencies make use of a reference or test signal. The supplying of such a signal to the input of the device may interfere with the desired signal, however. In order to avoid this, the signal processing that is normally taking place may be interrupted when a test signal is being supplied, but this is undesirable in most cases.

It is an object of the invention to overcome the aforesaid problems and to provide a device as described in the introduction in which an adequate mirror frequency suppression becomes possible substantially independently of the type of input signals.

In order to achieve said object, the device according to the invention is characterized in that a frequency generator is provided, which frequency generator supplies reference signals of a frequency which lies within the frequency band of the mirror signals to the input of the transformer unit. As a result, no interference of the input signal to be processed takes place, whilst the reference signals supplied by the frequency generator can be selected such that an amplitude and phase correction based on the information from the quadrature signals themselves becomes readily possible. The processing of signals need not be interrupted in that case.

The solution provided herein is possible when a reference signal of a fixed frequency lying within the mirror frequency band is used. Furthermore, it is possible for the frequency generator to be made up of a voltage-controlled oscillator and a time base voltage generator. The reference signal can be “swept” through the frequency band of the mirror signal in that case. It is also possible to take another type of wide-spectrum signal as the reference signal, for example the output signal from a noise generator. In that case, however, it will be desirable for the frequency generator to be connected to the correction control unit. Although the processing of signals need not be interrupted while the reference signal is being supplied, the frequency generator can be rendered inactive by the correction control unit if the quadrature channels are correctly tuned to each other.

Two embodiments will be explained in more detail below with reference to the accompanying drawing. In the drawing:

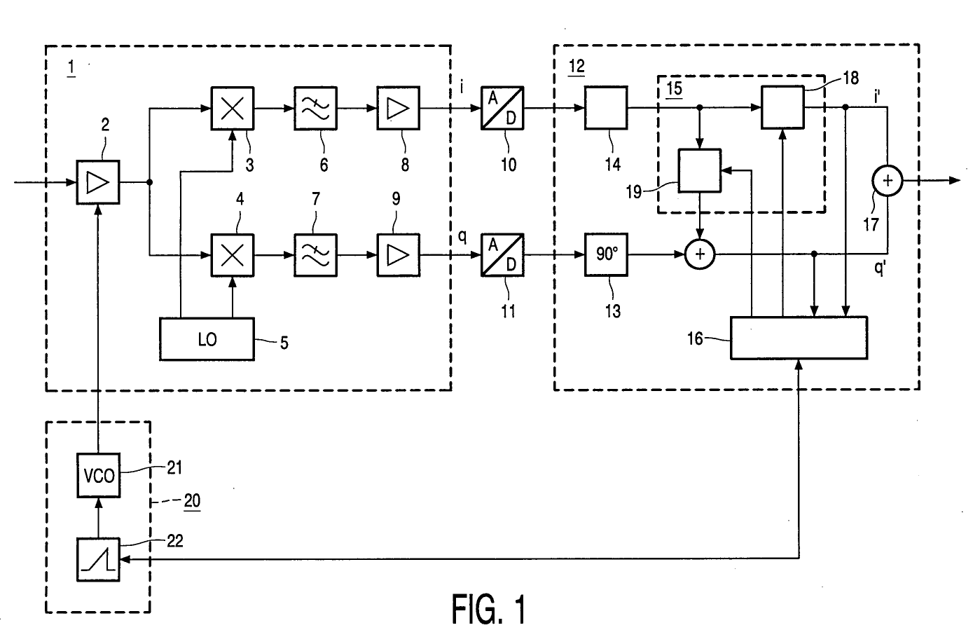

FIG. 1 shows a first embodiment, in which the desired mirror signal suppression is realized on a digital basis;

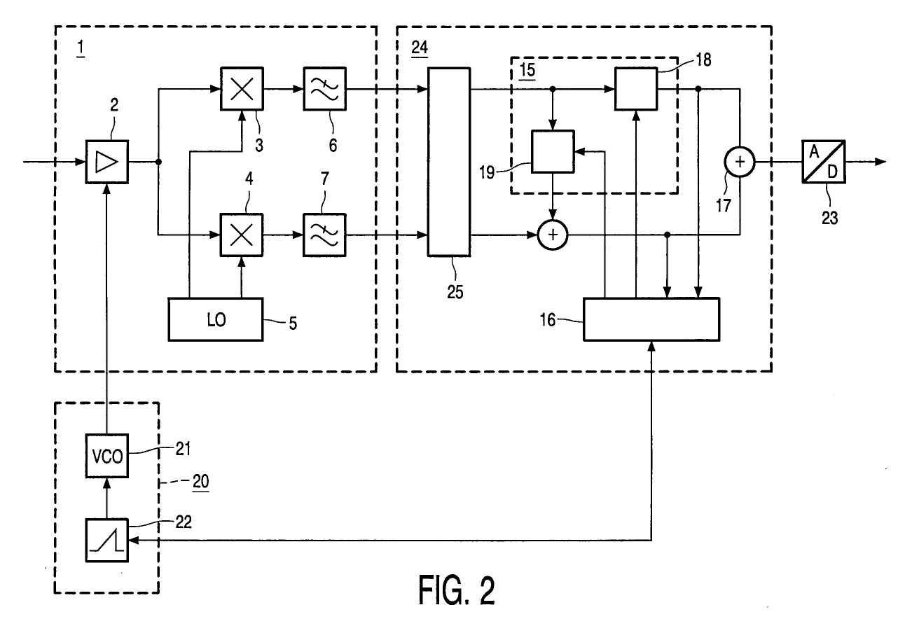

FIG. 2 shows a second embodiments, in which the desired mirror signal suppression is obtained on an analog basis; and

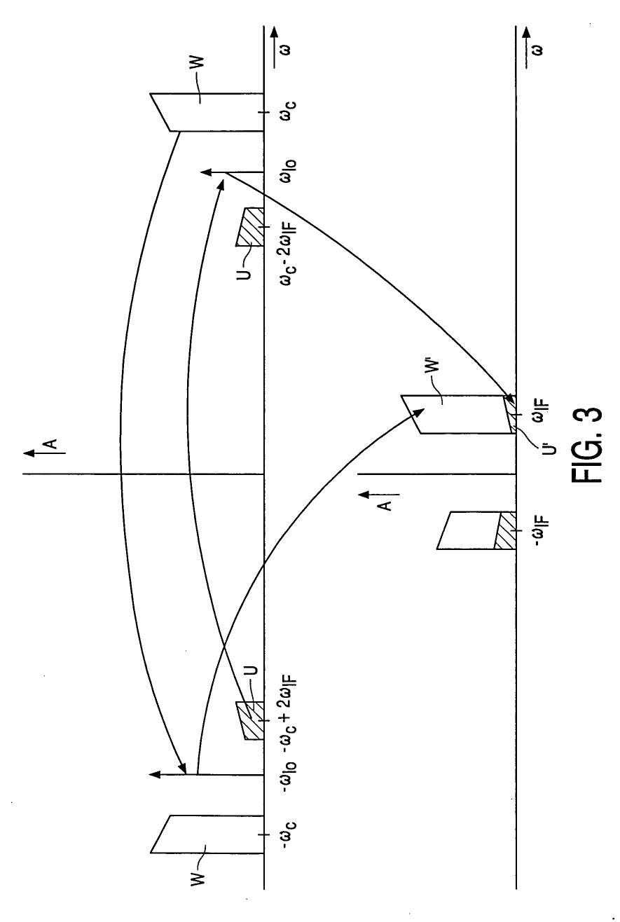

FIG. 3 shows a diagram in which the frequency band of the desired signal and that of the mirror signal are shown.

The device according to the invention shown in FIG. 1 comprises a transformer unit 1 with quadrature channels for transforming signals supplied thereto. Said transformer unit 1 may form the receiving portion of an FM receiver, for example. In the transformer unit, the radio frequency signals being received are transformed into medium frequency quadrature signals i and q by means of an oscillator signal having frequency ωₗₒ. To that end, the transformer unit conventionally comprises an amplifier 2, two mixing elements 3 and 4, an oscillator 5, filters 6 and 7 for suppressing the high-frequency components of the mixing elements, and amplifiers 8 and 9. Subsequently, the quadrature signals are digitized by means of A/D converters 10 and 11. Since differences in amplification and phase shift occur in practice in the quadrature channels, a situation which is called “mismatch” of the quadrature channels, so-termed mirror frequencies occur in the quadrature channels, i.e. a mirror signal having a frequency of ω_{c}-2ω_{if} occurs besides the desired signal frequency ω_{c}. This phenomenon can be reduced to a down transformation with signals cosωₗₒt and (1+Δa).sin(ωₗₒt+Δθ) from the oscillator 5, instead of a.cosωₗₒt and a.sinωₗₒt. FIG. 3 shows how the mirror frequencies that occur interfere with the desired signal. Not only is the desired signal W transformed down to the medium frequency ω_{if} (signal W′), but also the associated mirror frequencies are transformed to the frequency band of the signal W′. In order to suppress the mirror frequencies, a filter unit 12 is provided. This filter unit comprises a Hilbert filter 13, a delay element 14 for aligning the i-signal with the q-signal phase-shifted by the Hilbert filter, an amplitude and phase correction filter 15, a correction control unit 16 and a combination circuit 17. The amplitude and phase correction filter 15 comprises an amplitude correction filter 18 for introducing an amplitude correction into the i-channel and a phase correction filter 19 for introducing a phase correction into the q-channel. The amplitude and phase corrections are derived from the i′ and q′ signals at the inputs of the combination circuit 17. To that end, said signals are not only supplied to the combination circuit 17 but also to the correction control unit 16, in which an amplitude correction signal for the amplitude correction filter 18 is computed, as well as a phase correction signal for the phase correction filter 19. After correction, it obtains that i′ and q′ are identical for the desired signal and that i′ and q′ are identical but opposite in phase for a signal at the mirror frequency, so that the combination circuit 17 will only pass the desired signal. In a second combination circuit (not shown), only the signal at the mirror frequency may be passed, if desired, by deducting the signals i′ and q′ from each other.

Since it has become apparent in practice that it is not always possible to determine the amplitude and phase corrections from i′ and q′, a frequency generator 20 is provided. In a simple embodiment, said frequency generator generates a fixed-frequency ω-2ω_{if}, which lies within the mirror band U in FIG. 3. No interference of the desired signal having the frequency band W is caused thereby. After transformation to the medium frequency, the signal having this fixed frequency causes the generation of a mirror signal for determining the amplitude and phase corrections required for suppressing the mirror frequencies. For the determination of the corrections, a value of i′ and q′ averaged over the bandwidth is used.

A more precise mirror suppression is obtained if the frequency generator 20 is made up of a voltage controlled oscillator (VCO) 21 and a time base voltage generator 22, for example of a sawtooth voltage generator. In that case, all frequencies or some of the frequencies in the U band are supplied in succession as the reference signal. Every frequency in the U band has an associated corresponding frequency in the frequency band W of the desired signal. This makes it possible to determine, for every desired frequency, the corrections required for suppressing the corresponding mirror frequency. In order to do so, however, the correction control unit 16 needs the frequency information in question from the voltage generator 22. Instead of a sawtooth voltage generator, various other voltage generators may be used, even a (pseudo) random voltage generator (noise generator), provided that the information therefrom, i.e. the generating pattern, is passed on to the correction control unit 16.

The reference signal from the frequency generator 20 can be continuously supplied to the transformer unit 1; after all, the operation thereof need not be interrupted for selecting the frequency of the reference signal. It is nevertheless possible to discontinue the supply of the reference signal to the transformer unit when the two channels are matched. This can be effected by means of a signal from the correction control unit to the frequency generator or to a switch between the generator and the transformer unit.

In the present an embodiment, the amplitude and phase correction takes place on a digital basis; A/D converters are required for both quadrature channels in that case. It is also possible, however, to carry out the amplitude and phase correction on an analog basis. This situation is shown in FIG. 2. In that case only one A/D converter 23 is required for eventually obtaining the desired signal in digital form. In this embodiment, a filter unit 24 is arranged behind the transformer unit 1 instead of the filter unit 12. Said filter unit 24 comprises a polyphase filter 25, whilst furthermore the same amplitude and phase correction means are provided as in FIG. 1. Also in this embodiment, a reference signal having a frequency which lies in the mirror band U can be supplied to the transformer unit by means of the frequency generator 20, in the same manner as described with reference to FIG. 1, in order to obtain a signal in the U′ band, even in conditions in which it would normally be difficult to effect an amplitude and phase correction, so as to realize a desired mirror suppression.

The invention is not limited to the embodiments described herein with reference to the drawings; it also comprises all kinds of modifications thereto, obviously insofar as said modifications fall within the scope of the appended claims.

1. A device for down-transforming the frequency of signals, comprising a transformer unit with quadrature channels for transforming the signals into quadrature signals of a lower frequency, and a filter unit connected thereto for suppressing mirror frequencies occurring as a result of amplitude and phase errors in the quadrature signals, which filter unit comprises a controllable amplitude and phase correction filter for amplitude and phase correction of the quadrature signals, as well as a correction control unit which supplies the adjusting signals for the amplitude and phase correction filter in response to the output signals from said filter, characterized in that a frequency generator is provided, which frequency generator supplies reference signals having a frequency which lies within the frequency band of the mirror signals to the input of the transformer unit.

2. A device as claimed in claim 1, characterized in that the frequency generator is made up of a voltage-controlled oscillator and a time base voltage generator.

3. A device as claimed in claim 1 or 2, characterized in that the frequency generator is connected to the correction control unit.

4. A device as claimed in any one of the preceding claims, characterized in that the correction control unit is capable of generating a signal for blocking the supply of reference signals to the transformer unit.
